(19) United States
(12) Patent Application Publication
(10) Pub. No.: US 2025/0273956 A1
(43) Pub. Date: Aug. 28, 2025

(54) DECENTRALISED SYSTEM FOR CONTROLLING AN ELECTRICAL NETWORK

(71) Applicant: SAFRAN ELECTRICAL & POWER, Blagnac (FR)

(72) Inventors: Jérôme VALIRE, Moissy-Cramayel (FR); Abdellah CHERGUI, Moissy-Cramayel (FR); Jérémy PELE, Moissy-Cramayel (FR); Nadir HANI, Moissy-Cramayel (FR)

(73) Assignee: SAFRAN ELECTRICAL & POWER, Blagnac (FR)

(21) Appl. No.: 19/060,275

(22) Filed: Feb. 21, 2025

(30) Foreign Application Priority Data
Feb. 22, 2024 (FR) 2401764

(51) Int. Cl. H02J 3/00; H02J 4/00

(52) U.S. Cl. CPC H02J 3/001; H02J 3/0073; H02J 4/00; H02J 2310/44

(57) ABSTRACT

A decentralised system for controlling an electrical network of an aircraft, the system including a plurality of distinct cells, each cell including a plurality of electrical contactors and each cell being connected to an electrical supply. Each cell has at least one microcontroller for controlling at least one contactor.

### DESCRIPTION

### Technical Field

The invention relates to the field of controlling an electrical network of an aircraft.

### Prior Art

In a known manner, an aircraft comprises a primary electrical network and a secondary electrical network. These networks are distinct and each have their own functions.

The primary electrical network provides the main electrical supply to the aircraft. It is generally supplied by electricity generators, which are driven by the aircraft engines or by external sources, such as emergency generators or batteries. The voltage of the primary electrical network is generally 28, 115 or 230 volts in alternating current (AC). The primary electrical network supplies the equipment essential to the safety of the aircraft, such as the navigation systems, the communication systems and the flight-control systems. It also supplies certain non-essential equipment, such as the entertainment systems and the comfort systems.

The secondary electrical network provides the electrical supply to the majority of the non-essential equipment of the aircraft. It is generally supplied by the primary electrical network, but it may also be supplied by external sources, such as the batteries. The voltage of the secondary electrical network is generally 28 V DC or 115 V AC.

Generally, the secondary electrical network supplies the following equipment:
the cabin systems, such as the lighting systems, the air-conditioning systems and the entertainment systems;
the service equipment, such as the pressurisation systems and the air-conditioning systems;
the emergency equipment, such as the oxygen systems and the survival systems.

Usually, the two electrical networks are interconnected by contactors and circuit breakers. The circuit breakers make it possible to protect the electrical networks against overloads and short-circuits.

In the event of failure of the primary electrical network, the emergency electrical network can take over and supply the equipment essential to the safety of the aircraft.

In a known manner, a primary electrical network (also referred to as primary electrical distribution system) of an aircraft comprises a unit for controlling the electrical network (usually abbreviated to ENMU, standing for “Electrical Network Management Unit”) and is also a unit for controlling the power of the bus (usually abbreviated to BPCU, standing for “Bus Power Control Unit”). Usually, the ENMU and BPCU are grouped together in one and the same smart device that is responsible for management, distribution, protections and logic of the primary electrical network.

The control unit of the network monitors the parameters of the network in order to isolate the part of the electrical network in the event of a fault. The control unit of the network communicates with the other computers through a digital communication bus.

The control unit of the electrical network can be embedded inside an electrical core in the form of an electronic card with inputs/outputs. The electrical core being a smart box that represents the whole or a subassembly of the electrical distribution system and which groups together the elements for controlling, protecting, monitoring and distributing the power for the various loads of the aircraft.

The inputs/outputs can be discrete signals or analogue measurements of voltages and currents used by the distribution system or other computers of various types used in an aircraft.

Through its inputs, the control unit of the network controls the various switching members of the electrical cores such as the contactors.

In a known manner, all the information relating to the network reconfiguration and/or protection are centralised on one or more cards for providing redundancy solutions or for responding to dissimilarity problems.

Thus the control of the network is provided by one or more computers of one and the same card that receive all the information, configure, monitor, control and protect the network. This architecture makes it necessary to have all the actuation and control members in proximity to the card controlling the network. Which requires a specific organisation of the various actuation and control members and does not make it possible to easily modify the architecture to develop it. Furthermore, this architecture is not resilient in the event of failure of the control card of the network and does not make it possible to manage a large data flow. This is because the data flow is limited by the capacity of the microcontroller that centralises all the information.

Thus, in this context, it is necessary to provide a system for controlling an electrical network that is resilient in the event of failure and which is free from the constraints of the prior art.

### DISCLOSURE OF THE INVENTION

For this purpose, according to a first aspect, a decentralised system for controlling an electrical network of an aircraft is proposed, the system comprising a plurality of distinct cells, each cell comprising a plurality of electrical contactors and each cell being connected to an electrical supply. Each cell comprises at least one microcontroller for controlling at least one contactor.

The decentralisation of the system in particular affords better resilience of the system. This is because dividing the system into a plurality of independent cells makes it possible to guarantee the operation of the system in the event of failure of one of the cells (thus the system is resilient in the event of failure). Furthermore, decentralisation into a plurality of independent cells makes it possible to distribute the various cells while being free from the constraints of proximity of the centralised architectures of the prior art.

According to a particular provision, each cell comprises a microcontroller controlling a plurality of contactors of the cell.

According to a particular provision, each cell comprises as many microcontrollers as there are contactors, each microcontroller making it possible to independently control a corresponding contactor of the cell.

According to a particular provision, within one and the same cell the contactors are interfaced with each other by a digital communication network and/or a network exchanging physical information.

According to a particular provision, the cells are interfaced with each other by a digital communication network and/or a network exchanging physical information.

According to a particular provision, the contactors and/or the cells exchange electrical powers through the network exchanging physical information.

According to another aspect, an aircraft is proposed comprising a decentralised system for controlling an electrical network of an aircraft, the system comprising a plurality of distinct cells, each cell comprising a plurality of electrical contactors and each cell being connected to an electrical supply and each cell comprising at least one microcontroller for controlling at least one contactor of the cell.

According to a particular provision, at least one cell is connected to an electrical supply of a primary electrical network of the aircraft and at least one other cell is connected to an electrical supply of an emergency electrical network of the aircraft.

### BRIEF DESCRIPTION OF THE DRAWINGS

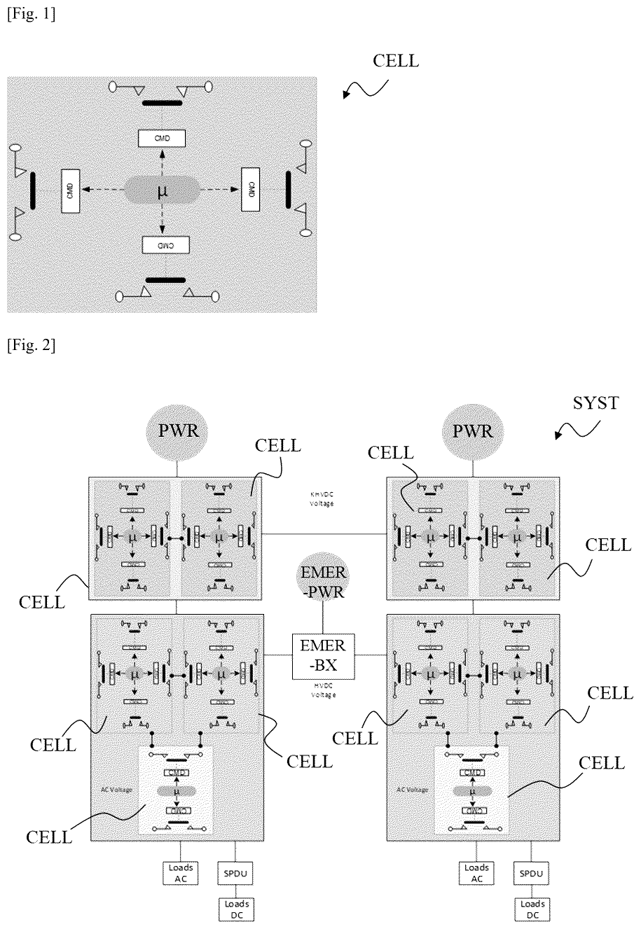

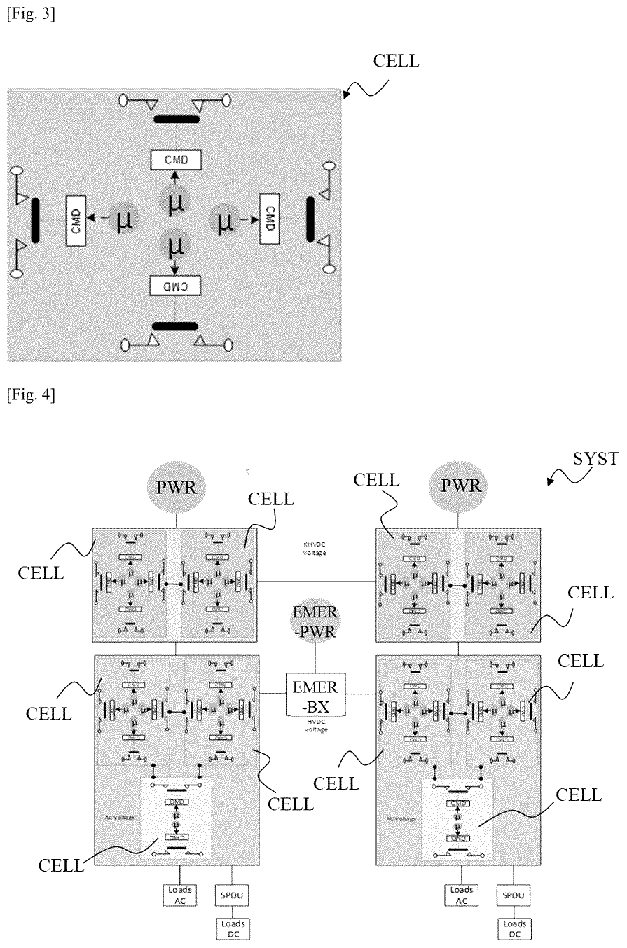

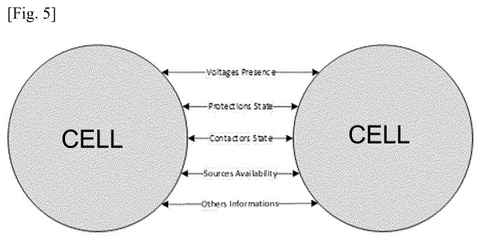

The features of the invention mentioned above, as well as others, will emerge more clearly from the reading of the following description of at least one example embodiment, said description being made in relation to the accompanying drawings, among which:

[FIG. 1] illustrates schematically a first embodiment of a decentralised system for controlling an electrical network of an aircraft;

[FIG. 2] illustrates schematically a first embodiment of a decentralised system for controlling an electrical network of an aircraft;

[FIG. 3] illustrates schematically a second embodiment of a decentralised system for controlling an electrical network of an aircraft;

[FIG. 4] illustrates schematically a second embodiment of a decentralised system for controlling an electrical network of an aircraft;

[FIG. 5] illustrates an example of information exchange between two interfaced cells.

### DETAILED DISCLOSURE OF EMBODIMENTS

### Decentralised System for Controlling an Electrical Network of an Aircraft

According to a first aspect, with reference to FIGS. 1 to 4, decentralised system SYST for controlling an electrical network of an aircraft is proposed. The system SYST comprises a plurality of distinct cells CELL. Each cell CELL comprises a plurality of electrical contactors CMD and each cell CELL is connected to an electrical supply PWR. Each cell CELL comprises at least one microcontroller μ for controlling at least one contactor CMD.

The decentralisation of the system SYST in particular affords better resilience of the system SYST. This is because dividing the system SYST into a plurality of independent cells CELL makes it possible to guarantee the operation of the system SYST in the event of failure of one of the cells CELL. Furthermore, decentralisation into a plurality of independent cells CELL makes it possible to distribute the various cells CELL while being free from the proximity constraints of the centralised architectures of the prior art.

Furthermore, this solution makes it possible to reduce the space requirements of the installations and cabling.

Furthermore, the solution also makes it possible to install the protections (i.e. the cells CELL) as close as possible to the electrical supplies PWR and thus reduce the latency times.

Furthermore, the decentralisation makes the system SYST more easily implementable, modifiable and reusable than the systems of the prior art.

### First Embodiment

According to a first embodiment shown schematically on FIGS. 1 and 2, each cell CELL comprises a microcontroller μ controlling a plurality of contactors CMD of the cell CELL. This arrangement enables each cell CELL to be independent and to be able to operate in the event of failure of another cell CELL. In addition, as will be developed hereinafter, this architecture makes it possible to easily reconfigure the system SYST to ensure operation thereof in the event of failure of a cell CELL. In other words, the fragmentation of the system SYST into a plurality of independent cells CELL each provided with a microcontroller μ enables the system SYST to be resilient in the event of failure of a cell CELL (the other cells CELL can replace the defective cell CELL), to be more rapid (there are several distinct cells CELL for processing the information), and to have a more adaptable architecture allowing modifications (it suffices to move the cells CELL, unlike the prior art, which imposes a centralisation around a single control system).

### Second Embodiment

According to a second embodiment shown schematically on FIGS. 3 and 4, each cell CELL comprises a microcontroller μ for each contactor CMD, each microcontroller μ making it possible to control each contactor CMD of the cell CELL independently.

This arrangement enables each cell CELL to be independent and to be able to operate in the event of failure of another cell CELL. In addition, this arrangement enables each contactor CMD in each cell CELL to be independent, which further increases the speed and resilience of the system SYST. In addition, as will be developed hereinafter, this architecture makes it possible to easily reconfigure the system SYST to ensure operation thereof in the event of failure of a cell CELL or of a failure of a contactor CMD in a cell CELL. In other words, the fragmentation of the system SYST into a plurality of independent cells CELL each provided with a plurality of independent microcontrollers enables the system SYST to be resilient in the event of failure of a cell CELL (the other cells CELL can replace the defective cell CELL), to be more rapid (there are several distinct cells CELL for processing the information), and to have a more adaptable architecture allowing modifications (it suffices to move the cells CELL, unlike the prior art, which imposes a centralisation around a single control system).

### Interfacing

As shown schematically on FIGS. 2 and 4, whatever the embodiment, within one and the same cell the contactors CMD are interfaced with each other by a digital communication network and/or a network exchanging physical information.

In addition, according to a particularly advantageous arrangement, as shown schematically on FIGS. 2, 4 and 5, whatever the embodiment, the cells CELL of the system SYST are interfaced with each other by the digital communication network and/or the network exchanging physical information.

Furthermore, according to a particularly advantageous provision, the contactors and/or the cells exchange electrical information through the system exchanging physical information PHY.

In other words, the cells CELL and the contactors CMD are interfaced, which makes it possible to maximise the information exchanges while affording a rapid exchange speed. In addition, the interfacing of the contactors CMD and of the cells CELL contributes to the resilience of the system SYTS by enabling each contactor and each cell to send and receive information. The interconnection of the cells CELL and of the contactors CMD makes it possible to construct an architecture of a completely autonomous multisource electrical network. This is because the interconnection of the cells CELL and of the contactors CMD allows a decentralised exchange of information. In other words, unlike the centralised devices of the prior art, the system SYST has a decentralised architecture in which the interconnection of the cells CELL and of the contactors CMD allows a rapid exchange of information between all the cells CELL. Thus, in the event of failure of a cell CELL, the interconnection allows a rapid adaptation of the system SYST.

Particularly advantageously, as shown schematically on FIGS. 2 and 4, a plurality of cells CELL can be interfaced with each other on various types of voltage: alternating current (abbreviated to AC), very high voltage direct current (abbreviated to KHVDC), high voltage direct current (abbreviated to HVDC) and low voltage direct current (abbreviated to LVDC).

FIG. 5 illustrates an example of information exchange between two interfaced cells CELL. The information exchanges make it possible, for example in the event of loss of a supply source on a right-hand side of an electrical distribution system, for the cells CELL to exchange the necessary information with each other in order to proceed with a reconfiguration of the network logic to continue to supply the members of the right-hand side in complete safety. It is specified that this example operates conversely with the left-hand side of the aircraft and of the electrical distribution system.

### Architecture and Control

FIGS. 2 and 4 present examples of architecture of a system SYST.

As indicated previously, the differences between the architectures in FIGS. 2 and 4 lie in the internal structures of the cells CELL. For the rest these two architectures are similar.

Thus, on FIGS. 2 and 4, the system SYST is divided into two sides RI and LE corresponding to the two sides of the aircraft in which the system SYST is incorporated.

Each side is supplied by a distinct electrical supply PWR.

Furthermore, as shown schematically, an emergency electrical supply EMER-PWR, connected to an emergency control member EMER-BX, is connected to the two sides.

Each side comprises a plurality of cells CELL.

As shown schematically, the cells CELL are interfaced. Furthermore, although this is not shown, the contactors CMD are also interfaced within one and the same cell CELL. Furthermore, particularly advantageously, the cells CELL on the two sides are interfaced, which makes it possible, in the event of failure of a cell CELL on one side, for another cell CELL on the same side or on the other side to replace the faulty cell CELL.

As detailed previously, the cells CELL of one and the same side are connected to various types of voltage (AC, DC, HVDC and KHVDC, which correspond in particular to primary and secondary electrical networks of the aircraft.

According to a particular provision, the system SYST is controlled according to a control and protection logic coordinated between the cells according to the location of a fault. In other words, advantageously, the system is controlled so that the location of a fault is taken into account to determine which cell must mitigate this fault.

According to a particular provision, the system can also implement one protection function per cell in order to apply a priority management specific to each electrical network in each cell.

According to a particular provision, the data exchanges are made according to a predetermined protocol. This provision makes it possible to optimise the system SYST by avoiding cells CELL reacting instantaneously and causing a conflict in the electrical network.

### Aircraft

According to a second aspect, an aircraft comprising the system SYST for controlling the electrical network is proposed.

According to a particular provision, at least one cell is connected to an electrical supply of a primary electrical network of the aircraft and at least one other dissimilar cell is 5 connected to an electrical supply of an emergency electrical network of the aircraft.

1. A decentralised system for controlling an electrical network of an aircraft, the system comprising a plurality of distinct cells, each cell comprising a plurality of electrical contactors and each cell being connected to an electrical supply wherein each cell comprises at least one microcontroller for controlling at least one contactor, and in that the cells are interfaced with each other by a digital communication network and/or a network for exchanging physical information, the cells exchanging electrical powers through the network exchanging physical information.

2. The system according to claim 1, wherein each cell comprises a microcontroller controlling a plurality of contactors of the cell.

3. The system according to claim 1, wherein each cell comprises as many microcontrollers as there are contactors, each microcontroller making it possible to independently control a corresponding contactor of the cell.

4. The system according to claim 1, wherein, within one and the same cell, the contactors are interfaced with each other by a digital communication network and/or a network exchanging physical information.

5. The system according to claim 4, wherein the contactors exchange electrical powers through the network exchanging physical information.

6. An aircraft comprising a decentralised system for controlling an electrical network of an aircraft, the system comprising a plurality of distinct cells, each cell comprising a plurality of electrical contactors, each cell being connected to an electrical supply, and each cell comprising at least one microcontroller for controlling at least one contactor of the cell, the cells being interfaced with each other by a digital communication network and/or a network exchanging physical information, the cells exchanging electrical powers through the network exchanging physical information.

7. The aircraft according to claim 6, wherein at least one cell is connected to an electrical supply of a primary electrical network of the aircraft and at least one other cell is connected to an electrical supply of an emergency electrical network of the aircraft.
